(19) United States
(12) Patent Application Publication
(10) Pub. No.: US 2011/0301752 A1
(43) Pub. Date: Dec. 8, 2011

(54) Reversing Mechanism For A Programmable Steerable Robot

(76) Inventor: Gedaliahu G. Finezilber, East Brunswick, NJ (US)

(21) Appl. No.: 13/154,421

(22) Filed: Jun. 6, 2011

Related U.S. Application Data
(60) Provisional application No. 61/351,832, filed on Jun. 4, 2010.

(51) Int. Cl. G06F 19/00

(52) U.S. Cl. 700/245; 901/23; 901/26; 901/1; 901/2

(57) ABSTRACT

A self-propelled programmable steerable robot (10) useful for cleaning a submerged surface of a swimming pool or tank, said robot comprising, a body member (11), a drive (40) included in the body member for rotatably driving a first shaft (53). A transmission (50) is also included in the body member, said transmission including said first shaft and said first shaft having fixed thereon in a spaced-apart opposed manner first and second beveled gears (55a, 55b). A second shaft (31) is positioned in orthogonal relationship to said first shaft, said second shaft having fixed thereon a third beveled gear (56) at a point on said second shaft so as to be able to alternately mesh with a selected one of said first and second beveled gears of said first shaft depending on the physical position of said second shaft. A shifting mechanism (60) for shifting said transmission and the position of said second shaft so as to change the direction of rotation of said second shaft, by causing said third beveled gear to selectively mesh with a selected one of said first and second beveled gears. At least one ground-engaging rotary propelling device (30a,30b) at one side of the body member is driven by said second shaft so as to propel said robot in a direction as controlled by said shifting mechanism.

### CROSS-REFERENCE TO RELATED APPLICATIONS

This application claims priority under 35 USC 120 of U.S. Patent Application No. 61/351832 filed Jun. 4, 2010, entitled “Improvements For Robotic Pool Cleaner Drive And Suction Mechanisms”. For at least US purposes, the entire disclosure of this prior patent application is incorporated herein by reference in its entirety.

### FIELD AND BACKGROUND OF THE INVENTION

The present invention relates to a reversing mechanism for a programmable steerable robot. The invention is particularly useful in a robot for cleaning swimming pools, and is therefore described below with respect to this application, but it will be appreciated that the invention could be used in many other applications, such as in toy robots, carpet cleaner robots, robotic lawn mower, and the like.

Programmable steerable robots are known in the prior art for cleaning swimming pools. Such known robots are self-propelled, either by self-contained electrical motor drives, or by hydraulic motor drives which are coupled to the swimming pool suction system via a suction hose, and within the housing of the robot, the suction force is used to drive a means, such as an impeller, which is then used to develop power, either mechanical or electrical, for propelling the robot. An example of an electrically-driven pool surface cleaning robot is described in U.S. Pat. No. 5,617,600; and an example of a hydraulically-driven pool surface cleaning robot is described in U.S. Pat. No. 5,001,800. Both types of robots are designed to function under water, and to be self-propelled so as to clean underwater surfaces of swimming pools. Both types are therefore generally programmable so as to automatically change the direction of travel according to the dimensions of the surfaces being cleaned.

My prior U.S. patent application Ser. No. 11/604,831 filed Nov. 28, 2006 entitled Programmable Steerable Robot Particularly Useful For Cleaning Swimming Pools, describes a cam and settable-pin based arrangement for effecting controllable steering. Such a programming device however, as a practical matter, is limited as to the various programs that can be preset. Accordingly a less complex steering control arrangement is desirable, yet it should also be more flexible in its ability to control steering of the robot.

### OBJECTS AND BRIEF SUMMARY OF THE PRESENT INVENTION

An object of the present invention is to provide a programmable steerable robot which permits a wide range of programs to be preset in a reliable and cost effective manner. Another object of the present invention is to provide a programmable steerable robot particularly useful for cleaning swimming pools and having advantages in the above respects.

According to a broad aspect of the present invention, there is provided a self-propelled programmable steerable robot useful for cleaning a submerged surface of a swimming pool or tank, said robot comprising, a body member, a drive included in the body member for rotatably driving a first shaft. A transmission is also included in the body member, said transmission including said first shaft and said first shaft having fixed thereon in a spaced-apart opposed manner first and second beveled gears. A second shaft is positioned in orthogonal relationship to said first shaft, said second shaft having fixed thereon a third beveled gear at a point on said second shaft so as to be able to alternately mesh with a selected one of said first and second beveled gears of said first shaft depending on the physical position of said second shaft. A shifting mechanism is provided for shifting said transmission and the position of said second shaft so as to change the direction of rotation of said second shaft, by causing said third beveled gear to selectively mesh with a selected one of said first and second beveled gears. At least one ground-engaging rotary propelling device at one side of the body member is driven by said second shaft so as to propel said robot in a direction as controlled by said shifting mechanism.

### BRIEF DESCRIPTION OF THE DRAWINGS

The accompanying drawings, which are incorporated herein and constitute part of this specification, illustrate embodiments and details of the invention and, together with the general description given above and the detailed description given below, serve to explain various embodiments and aspects of the invention. These drawings are exemplary and may not be to scale, and like reference numerals represent like elements throughout the several views, where:

FIG. 1 is a diagrammatic bottom view illustrating one form of programmable steerable robot constructed in accordance with the present invention;

FIGS. 2 and 3 illustrate one embodiment of the drive portion 40 and transmission portion 50 of the programmable steerable robot of FIG. 1;

FIGS. 4A, 4B and 4C illustrate various alternative embodiments of a mechanism 60;

FIGS. 5-9 illustrate an alternative embodiment of the transmission portion 50 of the programmable steerable robot of FIG. 1;

FIGS. 10 and 11A, 11B, 11C and 11D illustrate a further alternative embodiment of the drive portion 40 and transmission portion 50 of the programmable steerable robot of FIG. 1; and

FIGS. 12 and 13A and 13B illustrate an alternative embodiment of the invention where drive 40 is replaced by a hydraulic turbine 68a.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiment described is for purposes of example only, and that the invention is capable of being embodied in other forms and applications than described herein.

### DESCRIPTION OF A PREFERRED EMBODIMENT

As indicated earlier, the preferred embodiment of the invention illustrated in the drawings is a programmable steerable robot particularly useful for cleaning swimming pools. It includes a body member, generally designated 10; a pair of first ground-engaging rotary propelling devices 20a, 20b carried on opposite ends of one side of body member 10; and a second pair of ground-engaging rotary propelling devices 30a, 30b carried by the body member at opposite ends of the other side of the body member. Body member 10 also includes a rectangular frame or chassis 11 mounting within it a common drive, generally designated 40 for driving both pairs of rotary propelling devices; and a transmission system, generally designated 50, connecting the common drive 40 to both pairs of rotary propelling devices.

The two pairs of ground engaging rotary propelling devices 20a, 20b and 30a, 30b are rotatably mounted outwardly of opposite ends of frame 11. The first pair of rotary propelling devices 20a, 20b are coupled to drive 40 by a shaft 21 and a pulley belt 22 driven by a toothed pulley wheel 22a; whereas the second pair of rotary propelling devices 30a, 30b are coupled to the drive via a shaft 31 and pulley belt 32 driven by a toothed pulley wheel 32a. Each pulley belt 22, 32 includes a tensioning device 22b and 32b, respectively. Body member 10 further includes a side plate 12 covering pulley belt 22, and a second side plate 13 covering pulley belt 32.

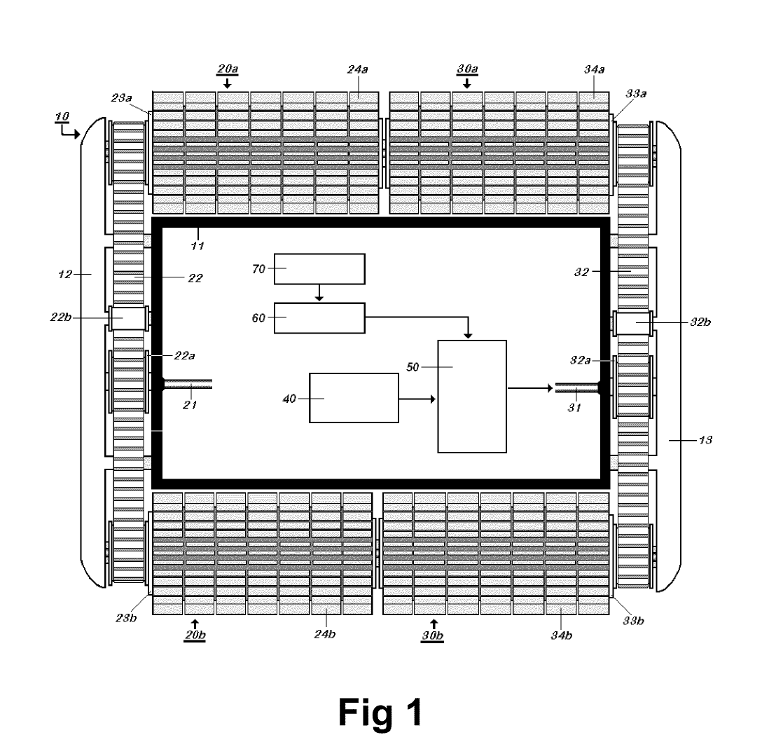

Each of the rotary propelling devices 20a, 20b and 30a, 30b, includes a drum 23a, 23b and 33a, 33b, driven by its respective pulley belt 22, 32. As shown in FIG. 1, each drum carries a plurality of externally-ribbed rubber belts or sheets 24a, 24b and 34a, 34b, respectively, in a close side-by-side relation. As is well known to those skilled in robotic swimming cleaner design, the buoyancy of the robot can be fixed such that the rotary propelling devices will firmly engage the surface along which the robot is propelled so as to produce no slippage therebetween, or only lightly engage such surfaces so as to produce some slippage therebetween and thus enhance the cleaning action of the robot.

Although the ground-engaging rotary propelling devices are shown in this embodiment operating as pairs, in an alternative embodiment, the ground-engaging rotary propelling devices can each comprise only one element, such as a single ground-engaging rotary propelling device that extends along each of the front and back portions of frame 11. Although such an arrangement will not allow left and right turn steerability, it will still be usable for an embodiment of the invention were only forward/backward control is desired.

A shifting device, generally designated 60, controls transmission system 50, as will be described more particularly below, such that for preselected travel intervals both pairs of rotary propelling devices are driven in the same direction to propel the body member 10 along a linear path, and for other preselected travel intervals one pair of rotary propelling devices is driven in one direction, whereas the other pair is controlled such that the body member is propelled along a curved path, that is, so that the robot 10 can be controlled so as to make one of a right turn, a left turn, travel forward or to travel in a reverse, i.e., backward, direction.

A control/programming device 70 provides input, either mechanically or electronically, as is described in more detail below, for activating said shifting device. Although not shown in greater detail but as well know, control/programming device 70 may include a printed circuit board for developing steering control signals that are applied to a motorized shifter device via either a preprogrammed schedule (such as by time), or, for example, can develop steering control signals via signals wireless received by device 70 from a user of the robot 10 who is operating a wireless remote control device of a design which is conventional for remote control of device, such as a toy car, etc.

As will described below, this control applied at latter intervals of travel of robot 10 can cause one pair of rotary propelling devices 20a, 20b, to be driven in one direction, and the other pair of rotary propelling devices 30a, 30b, to be driven in the opposite direction, such that the body member, during the latter intervals of travel, is propelled along a sharply curved path, i.e., is rotated about its central axis, to effectuate either a right or a left turn for robot 10. Alternatively, the control signals can cause both pairs of rotary propelling devices 20a and 30a to be driven in the same direction as rotary propelling devices 20b and 30b, so as to effectuate either forward or a backward intervals of travel (movement) for robot 10.

As previously noted, drive 40 provides power to transmission 50 (which is coupled to drive all the rotary propelling devices 20a, 20b and 30a, 30b), and can comprise either an electric or a hydraulic motor, depending upon design choice. In the illustrated embodiments both examples will be described. In the event that an electric motor is not used for drive 40, a suction driven turbine/generator set, as known in the art (see for example Maytronics US patent application publication 20090307854), can be used to create electricity for use by other components of the robotic cleaner, if necessary.

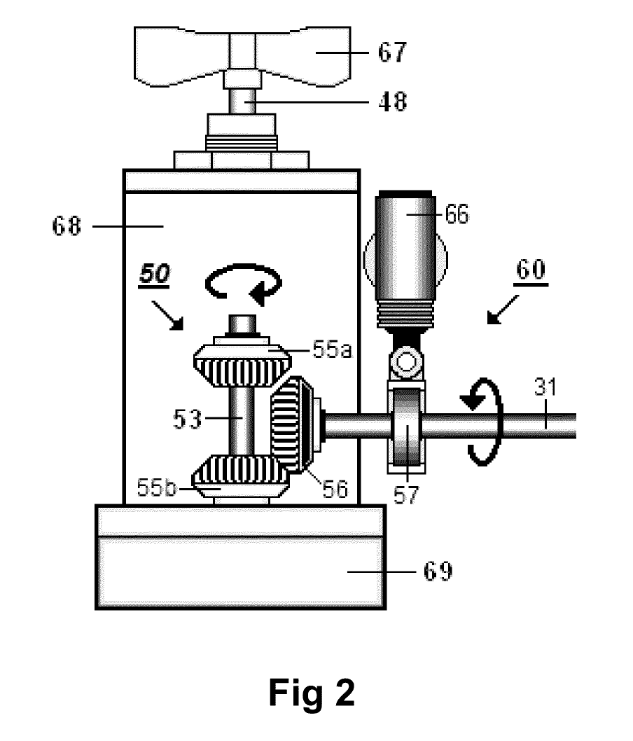

As shown in FIG. 2, in one embodiment of the invention drive 40 comprises an electric motor 68 which simultaneously provides the power necessary to drive the impeller portion 67 of a suction pump (the remainder of the suction pump is not specifically shown) and the rotary propelling devices 20a, 20b and 30a, 30b, through the use of the transmission 50 and the pulley belts 22 and 32. Electric motor 68 can be powered by either a rechargeable battery or a suitable power cable (neither power source being shown).

One end of an output shaft 48 is directly driven by motor 68 at a high speed rotation (about 3000 RPM), has one end coupled for rotating pump impeller 67, while the other end of shaft 48 of motor 68 is coupled as an input to a speed reduction gearbox 69. An output of gearbox 69 provides a first transmission shaft (rotating at about 50 RPM) for driving an output axle 53.

Transmission 50 has as its input axle 53. First and second stationary beveled gears 55a and 55b are mounted at a fixed position on axle 53 in an opposed relationship with the narrower side of each gear facing each other, with a proper distance/gap therebetween so as to allow a third beveled gear, noted below, to alternately be positioned between the opposed gears 55a and 55b and mesh therewith. Since impeller 67 is typically caused to only rotate in one direction so as to cause fluid flow in a preferred direction, both of the beveled gears 55a and 55b are also caused to constantly rotate in the same direction (either clockwise or anticlockwise), for example clockwise as shown on FIGS. 2-3 and 5-9.

Transmission 50 also includes a second shaft 31 (which may be the same shaft 31 shown in FIG. 1 for driving wheel 32a) positioned in orthogonal relationship to the first shaft 53, the second shaft 31 having fixed thereon a third beveled gear 56 at a point on the second shaft so as to be able to alternately mesh with a selected one of the first and second beveled gears of the first shaft.

The shifting mechanism 60 is provided for shifting the transmission so as to change the direction of rotation of the second shaft 31. This change in rotation is accomplished by said shifting mechanism selectively shifting the position of the end of shaft 31 which has the third beveled gear 56 attached thereto, so as to cause the third beveled gear 56 to selectively mesh with a selected one of the first and second beveled gears, and thereby rotate shaft 31 in one of either a clockwise or an anticlockwise direction. Since shaft 31 of FIG. 2 is the same as (or coupled to) shaft 31 of FIG. 1, in response to shifting mechanism 60 changing the position of gear 56 with relation to gears 55a or 55b, the robot is caused to travel in either a forward or backward manner. It is noted that a coupling mechanism not shown, but of a type well known by those of ordinary skill in the art, can be used to couple shaft 31 to shaft 21, so that both sides of the robot can simultaneously be driven in the same direction.

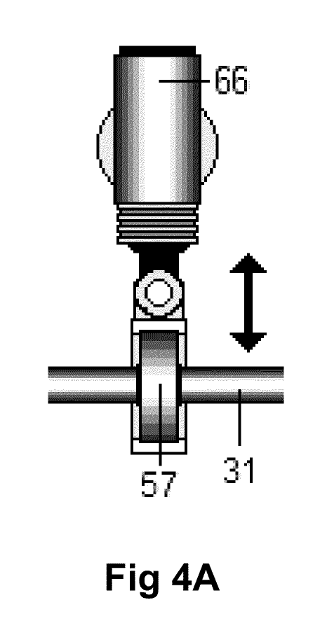

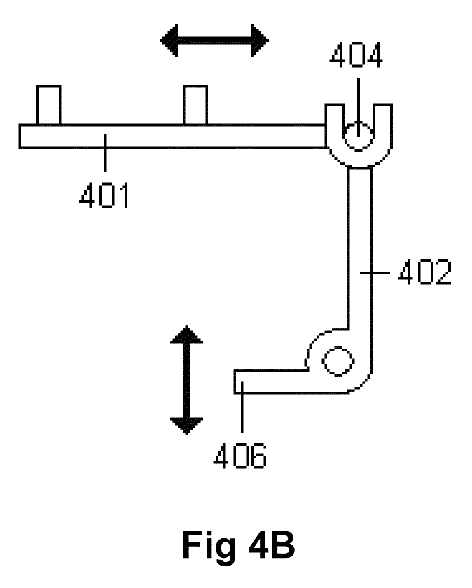

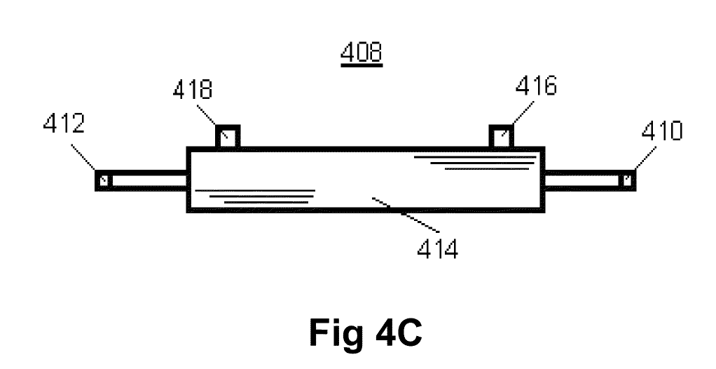

FIGS. 4A, 4B and 4C show three different examples of various alternative types of arrangements that can be used to provide the shifting mechanism 60.

In FIG. 4A, an electric motorized shifter 66 is shown for driving a rack and pinion (not specifically shown) so as to cause a linear movement which is applied to either push a cam follower bearing 57 for shifting the position of shaft 31, and thereby cause gear 56 and gear 55b to couple together, or to pull cam follower bearing 57 for shifting the position of shaft 31, and thereby cause gear 56 and gear 55a to couple together. As a result of the coupling, shaft 31 is selectively caused to rotate in either one of a counterclockwise or anti-clockwise direction, and thereby cause a selected one of a forward or reverse drive for the robot. A DC voltage of one polarity or a reverse polarity can be applied to the motorized shifter so as to make the motor rotate clockwise or anti-clockwise, and thereby cause a reversing of the linear movement of the rack portion of this shifter.

The programming/control 70 can provide the reversing polarity DC voltage at an appropriate time, as known by those of ordinary skill in the technology.

In FIG. 4B the shifter mechanism 60 is shown to comprise a mechanical linkage mechanism having a first member 401 coupled to a portion of the robot that undergoes a positional change at substantially the same time as a change in direction of travel of said robot, and a second member 402 coupled to the first portion via a pivot 404. One known device which can provide such positional change at the appropriate time comprises a shaft that passes through the robot and extends out from opposed sides of the robot body. When as a result of travel one side of the robot hits a wall portion, the extended shaft is forced by the wall to move into the robot body and further out the opposed end, such movement being coupled to move the first member 401 in one direction. When as a result of travel the other side of the robot hits a wall portion, the extended shaft is forced by the wall into the other side of the robot, such movement being coupled to move the first member 401 in an opposite direction. Additionally, it is also known from the Erlich U.S. Pat. No. 6,412,133, issued Jul. 2, 2002, to use a flap valve 46 to control the flow direction of a water jet that propels the robot in a given direction. Accordingly, member 401 can be coupled to the flap valve 46 for initiating operation of the shifter mechanism 60.

Second member 402 includes an end 406 which can push or pull cam follower bearing 57 in a manner substantially the same as noted above for electric motorized shifter 66, so as to cause a selected one of the forward or reverse drive for the robot.

In FIG. 4C the shifter mechanism is shown to comprise a hydraulic piston 408 having opposed ends 410 and 412 which extend from the body 414 of piston 408 upon application of a fluid pressure to a respective one of fluid inputs 416 and 418. In response to extension of a selected one of ends 410 or 412, cam follower bearing 57 is respectively pushed or pulled in a manner substantially the same as noted above for electric motorized shifter 66, so as to cause a selected one of the forward or reverse drive for the robot. A simple linkage, such as shown by member 401 of FIG. 4B can couple the ends 410 and 412 to respectively push or pull bearing 57.

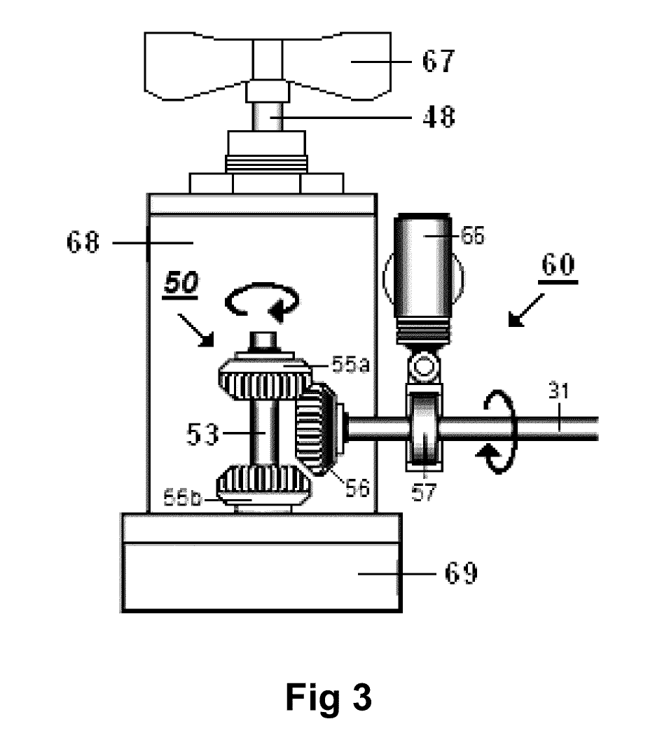

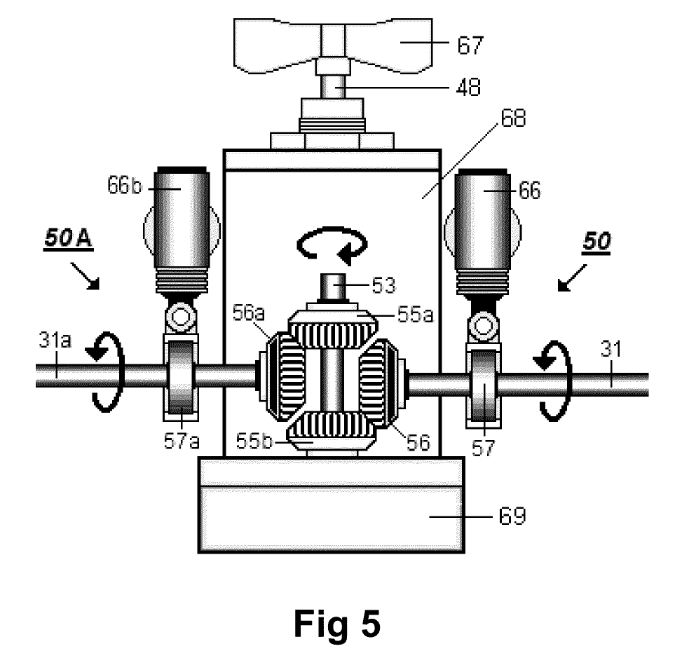

FIGS. 5-9 show a variation of the embodiment shown by FIGS. 2-3, where a second transmission portion 50A is shown for providing a controllable directional rotation for a shaft 31a, which can be coupled to shaft 21 for driving a second ground engaging rotary device which is located on an opposite side of the robot in a manner the same as or different from the driving of the ground engaging rotary device which is located on the other side of the robot, and thereby provide a controllable steering movement (left turn/right turn) of the robot as well as controllable linear movement (forward/backward) of the robot.

Accordingly, transmission portions 50 and 50A show a combination of gears which are coupled so as to provide forward drive for the robot when the shaft 53 is rotated clockwise. The electric motorized shifter 66 of transmission portion 50 is used to push or pull the cam follower bearing 57 as described above in FIGS. 2 and 3, causing gear 56 and one of gears 55a and 55b to couple together. An electric motorized shifter 66b of transmission portions 50A is used to push or pull a cam follower bearing 57a in a manner similar to what is described above in FIGS. 2 and 3, causing a gear 56a and one of gears 55a and 55b to couple together.

More specifically, as shown in FIG. 5, when gears 56 and 55b are coupled together and gears 56a and 55a are coupled together, both of the opposed ground engaging rotary devices are caused to rotate in the same direction (such as clockwise) and said robot is driven, for example, forward.

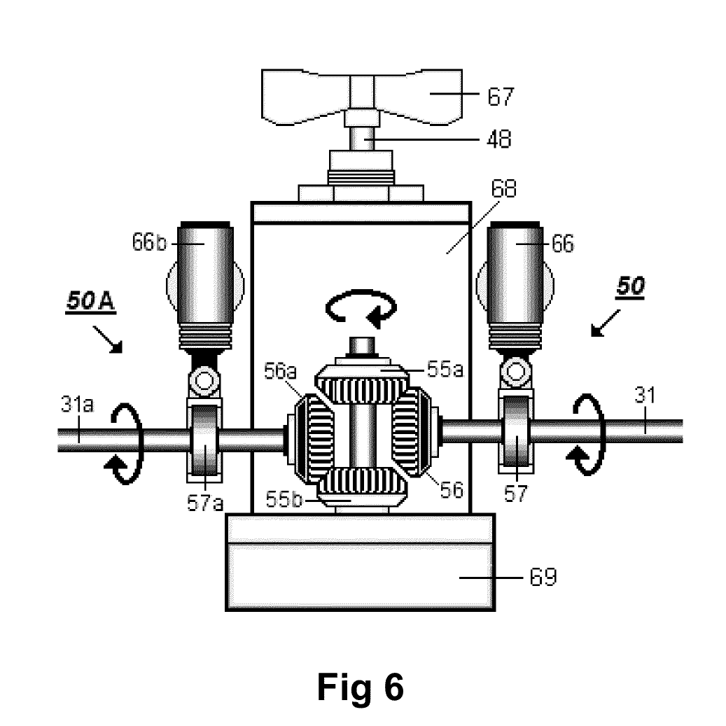

As shown in FIG. 6, when gears 56 and 55a are coupled together and gears 56a and 55b are coupled together, both of the opposed ground engaging rotary devices are caused to rotate in the same but opposite direction to that shown in FIG. 5 (such as anti-clockwise), and said robot is driven, for example, backward.

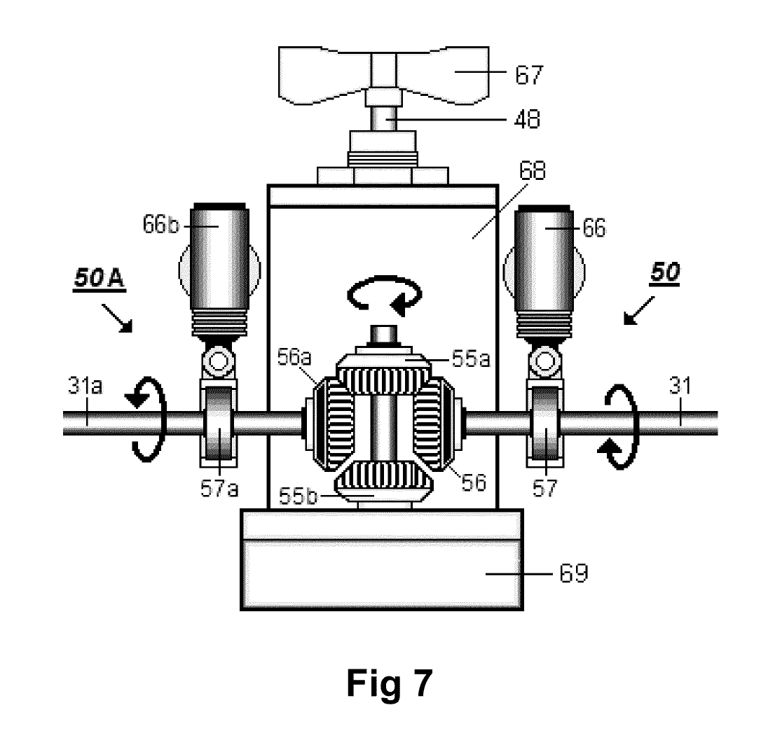

As shown in FIG. 7, when gears 56 and 56a are both coupled to gear 55a, the opposed ground engaging rotary devices are caused to rotate in opposite directions and said robot is driven, for example, so as to make a right turn.

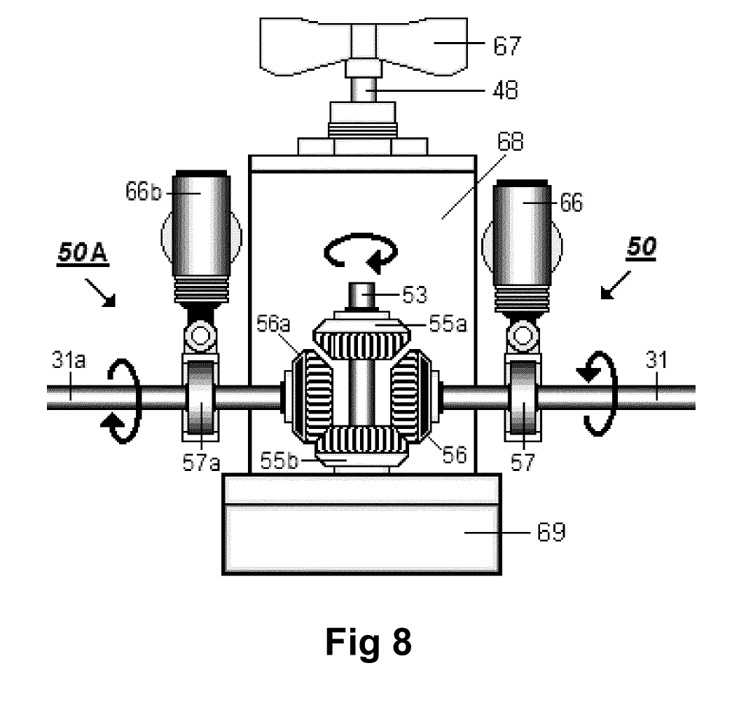

As shown in FIG. 8, when gears 56 and 56a are both coupled to gear 55b, the opposed ground engaging rotary devices are caused to rotate in opposite directions which are reverse from the directions shown in FIG. 7 and said robot is driven, for example, so as to make a left turn.

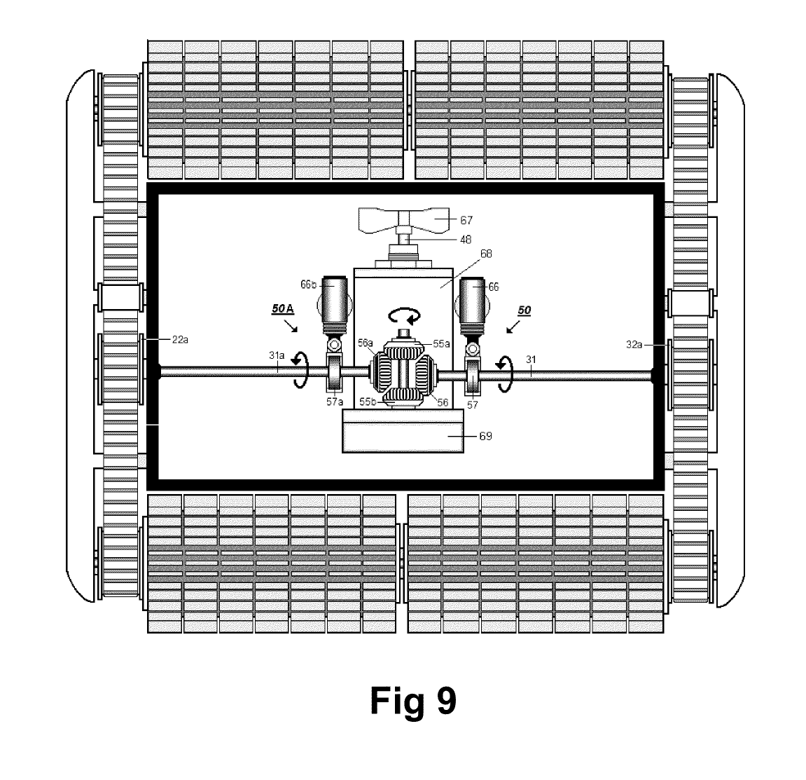

FIG. 9 shows a cut-away top view of the robotic cleaner such as shown by FIG. 1, modified so as to show the general location of the electric pump motor 68 and the transmissions 50 and 50A for driving shafts 31 and 31a. Note that shafts 31 and 31a are axles for toothed pulley wheels 22a and 32a, and therefore axle 21 shown in FIG. 1 may comprise shaft 31a, or shaft 31a may drive axle 21 via a gearing arrangement, not shown. Note also, for clarity purposes, the pump motor 68 and its related components are shown in a side elevation view. In practice, the pump motor 68 would be oriented perpendicular to the orientation shown, so that FIG. 9 would show a top view of the impeller 67.

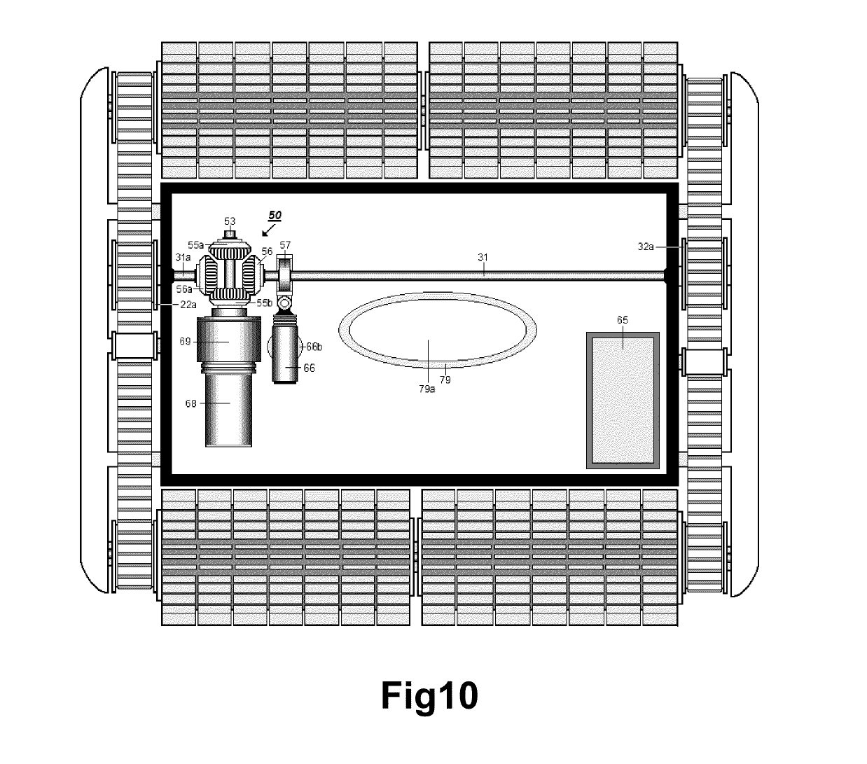

FIG. 10 shows another embodiment of a robotic pool cleaner which incorporates many of the improvements noted here. In this embodiment, electric motor 68 does not drive an impeller, and instead a source of suction is provided to the robot by a suction hose an inlet port 79 of the robot for creating a fluid flow through a passage 79a in the robot. The source of suction may be provided to the robot by a suction hose, for example, (not specifically shown) which is conventionally known to be coupled to the skimmer portion of a swimming pool to provide suction force to a robot swimming pool cleaner. A rechargeable DC battery 65 is provided in the body member 11 to power the electrical devices in the robot.

More specifically, as shown in FIG. 10, the robotic pool cleaner has a transmission 50 that uses a four beveled gear arrangement which is almost identical with that shown in FIGS. 5-9, except that the electric drive motor 68 is controllable so as to be reversible, since it is no longer being used to drive the impeller 67. As a result of motor 68 being reversible, the beveled gear which drives one of the ground engaging rotary devices does not require a shifter.

Accordingly, as previously described, the electric drive motor 68 drives a gearbox 69. Gearbox 69 has an output axle 53 with gears 55b and 55a mounted for permanently rotating in one direction, while gear 56a of axle 31a is permanently coupled with gear 55b. Axle 31a drives belt pulley 22a to nominally cause movement of the robotic cleaner in a first or second direction, such as forward and backward.

However, for controlling the rotational direction of axle 31, the motorized shifter 66 is used to selectively pull or push the cam follower bearing 57 for selectively coupling gear 56 with either one of gears 55b or gear 55a (in a manner as already shown and described in conjunction with FIGS. 5-9), so as to change the rotation direction of shaft 31, and hence the direction of rotation of belt pulley 32a. As previously described, by individually controlling the direction of rotation of axles 31 and 31a, one can both controllably steer and cause linear movement of the robotic pool cleaner.

Since electric drive motor 68 can easily change its direction of rotation alternately clockwise or anti-clockwise, by reversing the polarity of the DC voltage applied to the motor (using programming/controller portion 70, previously described, for controlling the polarity of the DC power applied to said motor), fully programmable steering is provided, that is: left and right turn and forward and backward movement.

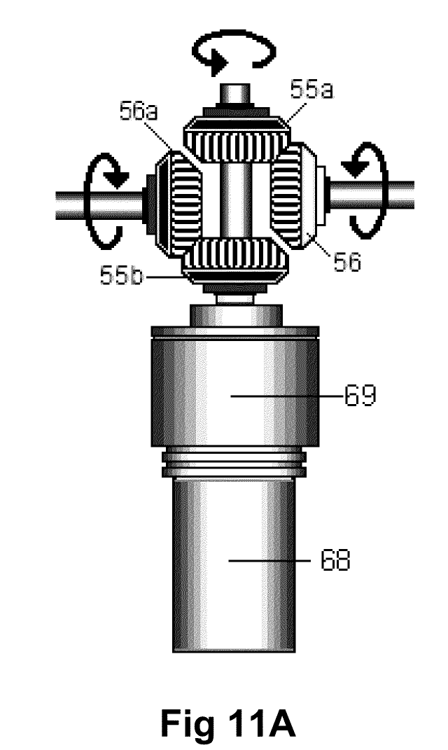

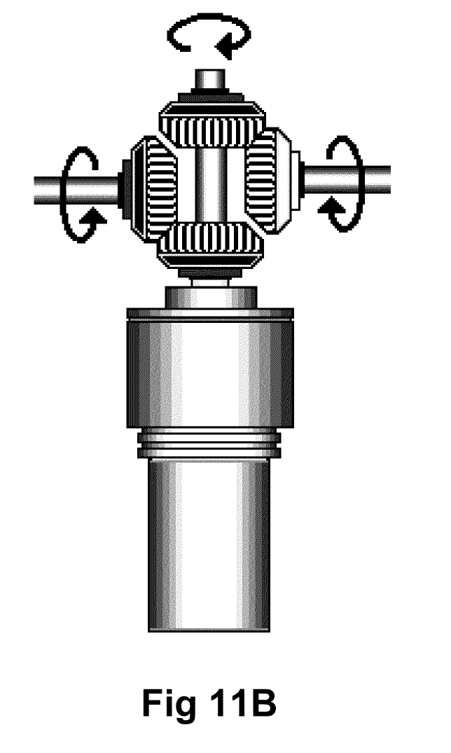

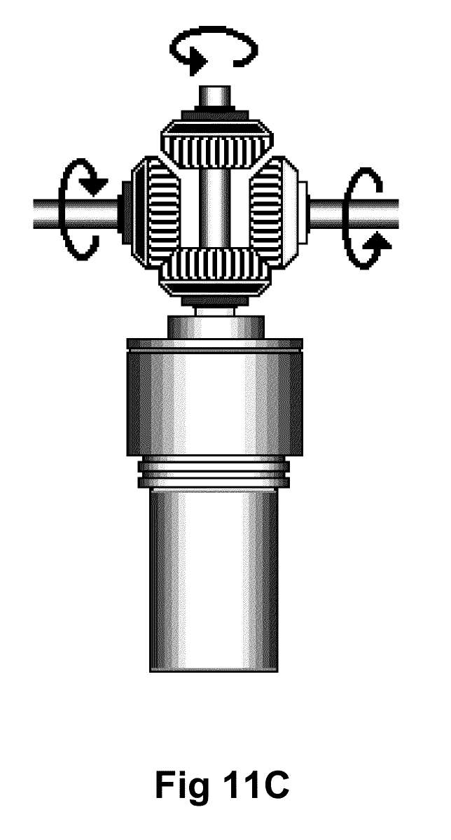

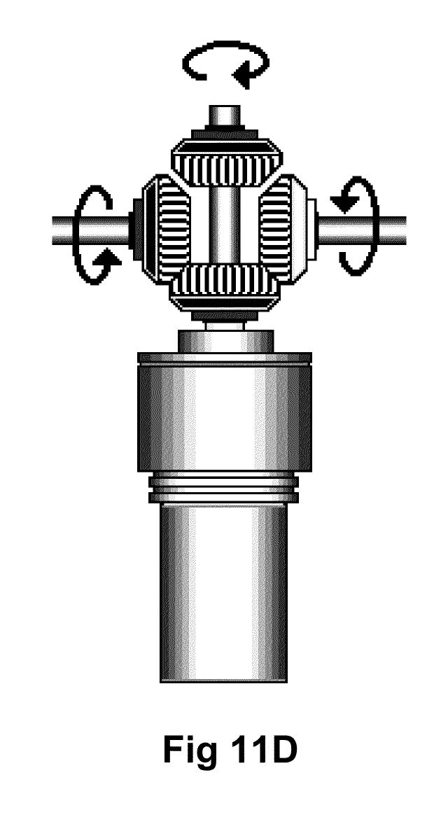

FIGS. 11A, 11B, 11C and 11D show a close-up view of the gear positioning achievable with the FIG. 10 embodiment in order to obtain forward, backward, left turn and right turn operation of the transmission. As noted above, the need to shift only one of the drive axles is achievable due to the use of reversible electric motor 68.

As shown in FIG. 11A when the shifter 66 causes the beveled gear 56 to mesh with beveled gear 55a and the reversible electric motor is caused to rotate in one direction, the first and second ground-engaging rotary propelling devices are both caused to rotate in the one direction, and thereby cause the robot to move in the first direction (forward).

As shown in FIG. 11B, when the shifter 66 still causes the beveled gear 56 to mesh with beveled gear 55a but the reversible electric motor is caused to rotate in a direction which is opposite the one direction, the first and second ground-engaging rotary propelling devices are both caused to rotate in direction which is opposite the one direction, and thereby cause the robot to move in the second direction (backward).

As shown in FIG. 11C, when the shifter 66 causes the beveled gear 56 to mesh with beveled gear 55b and the reversible electric motor is caused to rotate in the one direction, the first and second ground-engaging rotary propelling devices are caused to rotate in opposite directions, and thereby cause the robot to turn in a third direction (right).

As shown in FIG. 11D, when the shifter 66 causes the beveled gear 56 to continue to mesh with beveled gear 55b, but the reversible electric motor is caused to rotate in a direction opposite the one direction, the first and second ground-engaging rotary propelling devices are caused to change their rotational direction, and thereby cause the robot to turn in a fourth direction opposite to the third direction (left).

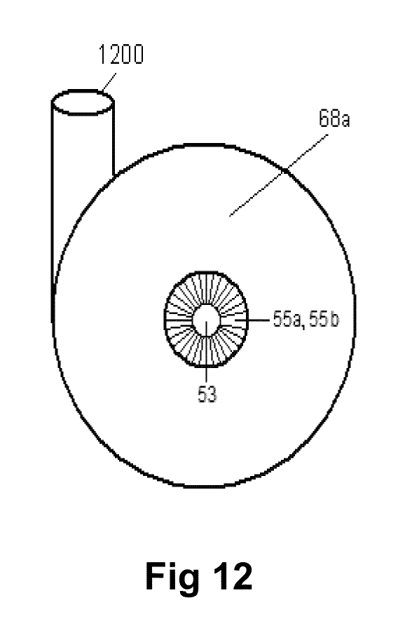

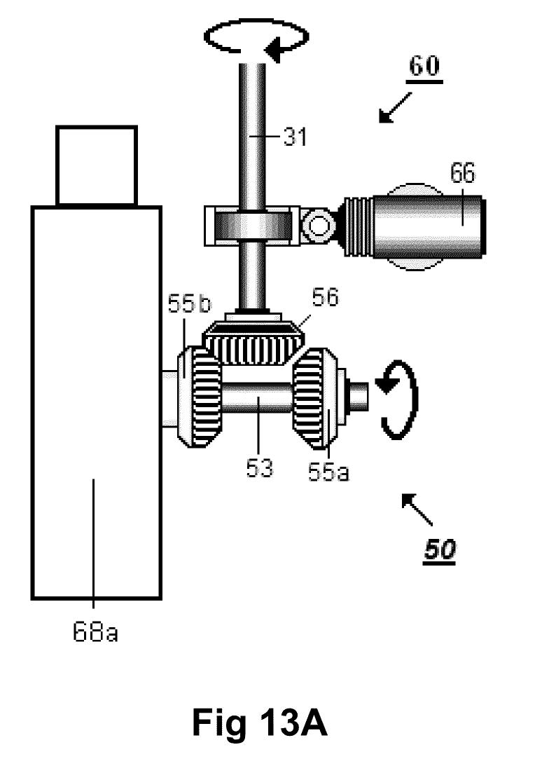

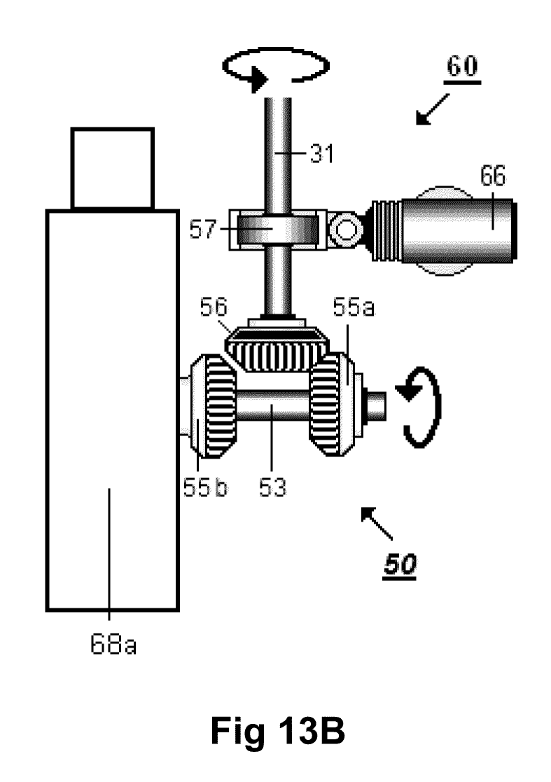

FIGS. 12 and 13A and 13B illustrate an alternative embodiment of the invention where motor 68 of drive 40 is replaced by a hydraulic turbine 68a. As shown in FIG. 12, hydraulic turbine 68a has a fluid input port 1200 for receiving a fluid flow that causes turbine blades arranged about a shaft 53, the blades not specifically shown but well known to those of ordinary skill in the art, so as to cause rotation of rotate shaft 53 in response to flow of fluid through turbine 68a. The remainder of this embodiment is of the same construction and operates in the same manner as the embodiment described in conjunction with FIGS. 2 and 3 as well as the modified embodiment of FIGS. 5-9, when an additional shaft 31a and shifter 66b, such as shown in FIGS. 5-9, are added to the embodiments of FIGS. 13A and 13B. Each of these embodiments can also be modified so as to have the same alternative embodiments for shifters 66 and 66b as shown by FIGS. 4A-4C.

While this invention has been particularly shown and described with references to preferred embodiments thereof, it will be understood by those skilled in the art that various changes in form and details may be made therein without departing from the sphere and scope of the invention. In fact, many such changes are already noted in this description but it should be realized that the above-noted changes were not exhaustive, and merely exemplary. For example, although two pairs of ground engaging rotary propelling devices 20a, 20b and 30a, 30b are shown rotatably mounted outwardly of opposite ends of frame 11, only a single rotary propelling device could be mounted on opposite ends of frame 11, such as an pulley belts 22 and 32 of FIG. 1, but enlarged so as to engage the pool surfaces (so as to operate in a manner similar to the tracks of a military tank). It is noted, however, that this limitation would only allow for front/back control, and not left/right control. In addition, the invention could be implemented in other types of robots, for example toy robots, carpet vacuuming robots, etc.

Thus, those skilled in the art will recognize, or be able to ascertain using no more than routine experimentation, many equivalents to the specific embodiments of the invention described herein. Accordingly, the following claims are intended to embrace all such alternatives, modifications and variations as falling within the spirit and broad scope of the invention.

What is claimed is:

1. A self-propelled programmable steerable robot for cleaning a submerged surface of a pool or tank, said robot comprising:
a body member;
a drive included in the body member, said drive rotatably driving a first shaft;
a transmission included in the body member, said transmission including:
said first shaft, said first shaft having fixed thereon in a spaced-apart opposed manner first and second beveled gears, and
a second shaft positioned in orthogonal relationship to said first shaft, said second shaft having fixed thereon a third beveled gear at a point on said second shaft so as to be able to alternately mesh with a selected one of said first and second beveled gears of said first shaft;
a shifting mechanism, for shifting said transmission so as to change the direction of rotation of said second shaft, by causing said third beveled gear to selectively mesh with a selected one of said first and second beveled gears; and
at least one ground-engaging rotary propelling device at one side of the body member, for being driven by said second shaft so as to propel said robot in a direction as controlled by said shifting mechanism.

2. The robot of claim 1, where said drive comprises an electric motor, said electric motor provides a relatively high-speed rotational drive for a third shaft for rotating an impeller in a preferred direction only, so as to create a flow of water through the body member of the robot, said third shaft being coupled so as to drive an input to a speed reduction gearbox, and said first shaft is driven by an output of speed reduction gearbox, so as to cause said first shaft to rotate at a relatively low-speed.

3. The robot of claim 1, further including a second ground-engaging rotary propelling device positioned at a side of said body member which is opposite said one side, said second ground-engaging rotary propelling device also being driven by said second shaft.

4. The robot of claim 2, further including a second ground-engaging rotary propelling device positioned at a side of said body member which is opposite said one side, a fourth shaft positioned in orthogonal relationship to said first shaft, said fourth shaft having fixed thereon a fourth beveled gear at a point on said fourth shaft so as to be able to alternately mesh with a selected one of said first and second beveled gears of said first shaft for shifting said transmission so as to change the direction of rotation of said fourth shaft, by causing said fourth beveled gear to selectively mesh with a selected one of said first and second beveled gears and thereby selectively drive said second ground-engaging rotary propelling device in one direction or an opposite direction.

5. The robot of claim 4, wherein:
a. when said first shifting mechanism causes said third beveled gear to mesh with said second beveled gear and said second shifting mechanism causes aid fourth beveled gear to mesh with said first beveled gear, said first and second ground-engaging rotary propelling devices are both caused to rotate in a first direction, and thereby propel said robot to move in said first direction (forward),
b. when said first shifting mechanism causes said third beveled gear to mesh with said first beveled gear and said second shifting mechanism causes aid fourth beveled gear to mesh with said second beveled gear, said first and second ground-engaging rotary propelling devices are caused to rotate in a direction opposite said first direction, and thereby propel said robot to move in said opposite direction (backward),
c. when said first shifting mechanism causes said third beveled gear to mesh with said first beveled gear, and said second shifting mechanism causes said fourth beveled gear to also mesh with said first beveled gear, said first and second ground-engaging rotary propelling devices are caused to rotate in opposite directions, and thereby cause said robot to turn in one direction (left), and
d. when said first shifting mechanism causes said third beveled gear to mesh with said second beveled gear, and said second shifting mechanism causes said fourth beveled gear to also mesh with said second beveled gear, said first and second ground-engaging rotary propelling devices are caused to reverse their direction of rotation, but to still rotate in opposite directions, and thereby cause said robot to turn in an opposite direction (right).

6. The robot of claim 1, where said drive comprises a reversible electric motor.

7. The robot of claim 6, further including:
a. a programmable controller which is able to be programmed so as to develop control signals which are applied to said reversible electric motor so as to cause said motor to reverse the direction of rotation of said first shaft;
b. a second ground-engaging rotary propelling device positioned at a side of said body member which is opposite said one side; and
c. a fourth shaft positioned in orthogonal relationship to said first shaft, said fourth shaft having fixed thereon a fourth beveled gear at a point on said fourth shaft so as to be able to constantly mesh with one of said first and second beveled gears of said first shaft, thereby driving said second ground-engaging rotary propelling device in one direction or an opposite direction, depending upon the rotational direction of said first shaft.

8. The robot of claim 7 where said fourth beveled gear constantly meshes with said second beveled gear, and wherein:
a. when said shifting mechanism causes said third beveled gear to mesh with said first beveled gear and said reversible electric motor is caused to rotate in one direction, said first and second ground-engaging rotary propelling devices are both caused to rotate in a first direction, and thereby cause said robot to move in said first direction (forward);
b. when said shifting mechanism continues to cause said third beveled gear to mesh with said first beveled gear but said reversible electric motor is caused to rotate in a direction opposite said one direction, said first and second ground-engaging rotary propelling devices are both caused to rotate in a direction opposite said first direction, and thereby cause said robot to move in a direction opposite said first direction (backward);
c. when said shifting mechanism causes said third beveled gear to mesh with said second beveled gear and said reversible electric motor is caused to rotate in said one direction, said first and second ground-engaging rotary propelling devices are caused to rotate in opposite directions, and thereby cause said robot to turn in a third direction (right);
d. when said shifting mechanism continues to cause said third beveled gear to mesh with said second beveled gear but said reversible electric motor is caused to rotate in a direction opposite said one direction, said first and second ground-engaging rotary propelling devices are caused to change their rotational direction, and thereby cause said robot to turn in a fourth direction opposite to said third direction (left).

9. The robot of claim 1, where said drive comprises a hydraulic motor, said hydraulic motor having an input driven by a flow of water that passes through at least a portion of said body member of the robot, and said hydraulic motor having an output which is coupled so as to rotationally drive said first shaft.

10. The robot of claim 9, further including a second ground-engaging rotary propelling device positioned at a side of said body member which is opposite said one side, said second ground-engaging rotary propelling device also being driven by said second shaft.

11. The robot of claim 9, further including:
a. a second ground-engaging rotary propelling device positioned at a side of said body member which is opposite said one side, and
b. a fourth shaft positioned in orthogonal relationship to said first shaft, said fourth shaft having fixed thereon a fourth beveled gear at a point on said fourth shaft so as to be able to alternately mesh with a selected one of said first and second beveled gears of said first shaft for shifting said transmission so as to change the direction of rotation of said fourth shaft, by causing said fourth beveled gear to selectively mesh with a selected one of said first and second beveled gears and thereby selectively drive said second ground-engaging rotary propelling device in one direction or an opposite direction.

12. The robot of claim 11, wherein
a. when said first shifting mechanism causes said third beveled gear to mesh with said second beveled gear and said second shifting mechanism causes aid fourth beveled gear to mesh with said first beveled gear, said first and second ground-engaging rotary propelling devices are both caused to rotate in a first direction, and thereby propel said robot to move in said first direction (forward),
b. when said first shifting mechanism causes said third beveled gear to mesh with said first beveled gear and said second shifting mechanism causes aid fourth beveled gear to mesh with said second beveled gear, said first and second ground-engaging rotary propelling devices are caused to rotate in a direction opposite said first direction, and thereby propel said robot to move in said opposite direction (backward),
c. when said first shifting mechanism causes said third beveled gear to mesh with said first beveled gear, and said second shifting mechanism causes said fourth beveled gear to also mesh with said first beveled gear, said first and second ground-engaging rotary propelling devices are caused to rotate in opposite directions, and thereby cause said robot to turn in one direction (left), and
d. when said first shifting mechanism causes said third beveled gear to mesh with said second beveled gear, and said second shifting mechanism causes said fourth beveled gear to also mesh with said second beveled gear, said first and second ground-engaging rotary propelling devices are caused to reverse their direction of rotation, but to still rotate in opposite directions, and thereby cause said robot to turn in an opposite direction (right)

13. The robot of claim 4, wherein said shifter mechanism comprises an electric motor for driving a rack and pinion so as to cause a linear movement for shifting the position of said second shaft and thereby selectively control the meshing of said third beveled gear with a selected one of said first and second beveled gears.

14. The robot of claim 4, wherein said shifter mechanism comprises a mechanical linkage mechanism having a first member coupled to a portion of said robot that undergoes a positional change at substantially the same time as a change in direction of travel of said robot, and a second member coupled to said second shaft for shifting the position of said second shaft and thereby selectively control the meshing of said third beveled gear with a selected one of said first and second beveled gears.

15. The robot of claim 4, wherein said shifter mechanism comprises a hydraulic piston which undergoes a positional change at substantially the same time as a change in direction of travel of said robot, said piston being coupled to shift the position of said second shaft and thereby selectively control the meshing of said third beveled gear with a selected one of said first and second beveled gears.

16. The robot of claim 6, wherein said shifter mechanism comprises an electric motor for driving a rack and pinion so as to cause a linear movement for shifting the position of said second shaft and thereby selectively control the meshing of said third beveled gear with a selected one of said first and second beveled gears.

17. The robot of claim 6, wherein said shifter mechanism comprises a mechanical linkage mechanism having a first member coupled to a portion of said robot that undergoes a positional change at substantially the same time as a change in direction of travel of said robot, and a second member coupled to said second shaft for shifting the position of said second shaft and thereby selectively control the meshing of said third beveled gear with a selected one of said first and second beveled gears.

18. The robot of claim 6, wherein said shifter mechanism comprises a hydraulic piston which undergoes a positional change at substantially the same time as a change in direction of travel of said robot, said piston being coupled to shift the position of said second shaft and thereby selectively control the meshing of said third beveled gear with a selected one of said first and second beveled gears.

19. The robot of claim 9, wherein said shifter mechanism comprises an electric motor for driving a rack and pinion so as to cause a linear movement for shifting the position of said second shaft and thereby selectively control the meshing of said third beveled gear with a selected one of said first and second beveled gears.

20. The robot of claim 9, wherein said shifter mechanism comprises a mechanical linkage mechanism having a first member coupled to a portion of said robot that undergoes a positional change at substantially the same time as a change in direction of travel of said robot, and a second member coupled to said second shaft for shifting the position of said second shaft and thereby selectively control the meshing of said third beveled gear with a selected one of said first and second beveled gears.

21. The robot of claim 9, wherein said shifter mechanism comprises a hydraulic piston which undergoes a positional change at substantially the same time as a change in direction of travel of said robot, said piston being coupled to shift the position of said second shaft and thereby selectively control the meshing of said third beveled gear with a selected one of said first and second beveled gears.
